(19) United States
(12) Patent Application Publication
(10) Pub. No.: US 2011/0221664 A1
(43) Pub. Date: Sep. 15, 2011

(54) VIEW NAVIGATION ON MOBILE DEVICE

(75) Inventors: Billy Chen, Bellevue, WA (US); Eyal Ofek, Redmond, WA (US); David Z. Nister, Bellevue, WA (US)

(73) Assignee: Microsoft Corporation, Redmond, WA (US)

(21) Appl. No.: 12/721,684

(22) Filed: Mar. 11, 2010

(51) Int. Cl. G09G 5/00; G06F 3/048; H04B 1/38

(52) U.S. Cl. 345/156; 715/781; 455/566

(57) ABSTRACT

Users may view web pages, play games, send emails, take photos, and perform other tasks using mobile devices. Unfortunately, the limited screen size and resolution of mobile devices may restrict users from adequately viewing virtual objects, such as maps, images, email, user interfaces, etc. Accordingly, one or more systems and/or techniques for displaying portions of virtual objects on a mobile device are disclosed herein. A mobile device may be configured with one or more sensors (e.g., a digital camera, an accelerometer, or a magnetometer) configured to detect motion of the mobile device (e.g., a pan, tilt, or forward/backward motion). A portion of a virtual object may be determined based upon the detected motion and displayed on the mobile device. For example, a view of a top portion of an email may be displayed on a cell phone based upon the user panning the cell phone in an upward direction.

### BACKGROUND

Today, mobile devices are becoming increasingly connected, powerful, and versatile. Mobile devices are able to perform many tasks that previously required a personal computer for operation. Some features of mobile devices may comprise internet connectivity, digital cameras, GPS, compasses, accelerometers, operating systems, etc. In one example, a mobile device may allow a user to view virtual objects, such as a map, a text document, an application, a web page, e-mail, etc. Unfortunately, the limited size of mobile devices may restrict the ability of a user to adequately view these virtual objects. For example, a map virtual object may be formatted to reside in 36 by 24 inches of virtual space. However, a mobile device in which a user views the virtual map object may only be 3 by 2 inches. Current techniques for viewing virtual objects on the small screens of mobile devices (e.g., finger gestures, buttons, etc.) are unintuitive and detract from the user's interactive experience with the virtual objects.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Among other things, one or more systems and/or techniques for displaying portions of virtual objects on a mobile device are disclosed herein. It may be appreciated that a virtual object may comprise objects, such as user interface elements and/or documents that may be electronically displayed (e.g., an application, an image, a web page, text, etc.). It may be appreciated that a potion of a virtual object may be interpreted as a view of a region of the virtual object, which may be displayed on a screen of the mobile device. A first portion of a virtual object may be displayed on a mobile device. For example, a first portion of a text document corresponding to the upper left hand region of the text document may be displayed.

Motion of the mobile device may be detected. For example, a digital camera, an accelerometer, a magnetometer, and/or other mobile device components may be utilized to detect the motion. The motion may comprise a pan, a tilt, a roll, forward/backward motion, and/or other movement of the mobile device. It may be appreciated that the motion may be detected by one or more mobile device components (e.g., a combination of a digital camera and an accelerometer). A second portion of the virtual object may be determined based upon the motion. For example, a second portion of a text document may be determined based upon executing dense or sparse optical flow estimation upon a stream of image frames of motion detected by a digital camera. The second portion of the virtual object may be displayed on the mobile device.

It may be appreciated that motion may comprise a single motion measurement of the mobile device or a series of motion measurements of the mobile device. It may be appreciated that a series of portions of the virtual object may be determined and displayed in succession to facilitate smooth navigation of a virtual object.

In another example, motion of the mobile device may be mapped to one or more applications within the mobile device. An application may be launched (executed) based upon detected motion corresponding to the application.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of displaying a portion of a virtual object on a mobile device.

FIG. 2 is a component block diagram illustrating an exemplary system for displaying a portion of a virtual object on a mobile device.

FIG. 3A is an illustration of an example of a user panning a mobile device to the right.

FIG. 3B is an illustration of an example of a user moving a mobile device away from the user.

FIG. 3C is an illustration of an example of a user tilting a mobile device in a counterclockwise direction.

FIG. 4 is an illustration of an example of a cell phone mobile device comprising a digital camera, an accelerometer, and a magnetometer.

FIG. 5 is an illustration of an example of displaying a first portion of an email virtual object and subsequently a second portion of the email virtual object based upon motion of a PDA mobile device.

FIG. 6 is an illustration of an example of displaying a first portion of an image virtual object and subsequently a second portion of the image virtual object based upon motion of a cell phone mobile device.

FIG. 7 is an illustration of an example of displaying a first portion of an image virtual object and subsequently a second portion based upon motion of a mobile device.

FIG. 8 is an illustration of an exemplary computer-readable medium wherein processor-executable instructions configured to embody one or more of the provisions set forth herein may be comprised.

FIG. 9 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

Many mobile devices, such as smart phones and PDAs, have substantial hardware capabilities that enable a plethora of applications for the mobile devices. Users may watch movies, play games, share photos, map directions, develop documents, interact with email, and perform a vast array of other tasks using a mobile device. In this way, a mobile device may display a wide variety of virtual objects. For example, content of a web page, a text document, an email, a photo, and a user interface application to name a few may be displayed on a screen of the mobile device. Unfortunately, mobile devices comprise small screens with low resolutions. The small screen of a mobile device may restrict a user's ability to adequately view virtual objects that may be formatted larger than the screen. For example, a text document may be developed and formatted at 8.5 by 11 inches. A mobile device with a 3 by 2 inch screen may not display the text document adequately because of zooming and/or other viewing issues.

Current solutions may utilize finger and/or button based interactions to perform viewing functions, such as zooming. In one example, a user may hold a mobile device in one hand and pinch two fingers to perform a zoom function on a virtual object (e.g., zoom in on a view of a map). In another example, a user may hold the mobile device in one hand and swipe a finger across the screen to perform a pan function on the virtual object. These gestures are not a natural way to view virtual objects. For example, people view objects by panning, tilting, twisting their head, whereas many current techniques for viewing virtual objects utilize two hands.

Accordingly, one or more systems and/or techniques for displaying portions of a virtual object on a mobile device are provided herein. Today, many mobile devices comprise one or more components that may be utilized in detecting motion. In one example, a digital camera may capture a stream of images that may be utilized in detecting motion. In another example, a magnetometer may measure changes in direction (N, S, E, W) of the mobile device that may be utilized in detecting motion. The detect motion may be used to determine portions of a virtual object to display. For example, a first portion of a map may be displayed on a mobile device. A user may pan the mobile device in a downward motion, which may be detected by an accelerometer as acceleration. A second portion of the map may be determined based upon the detected downward motion derived from the acceleration. The second portion of the map may be displayed on the mobile device, such that the second portion corresponds to a view of the map as though the map was panned in a downward motion. This allows the user to pan, zoom, and/or alter the view of a virtual object in a natural way with a single hand moving the mobile device.

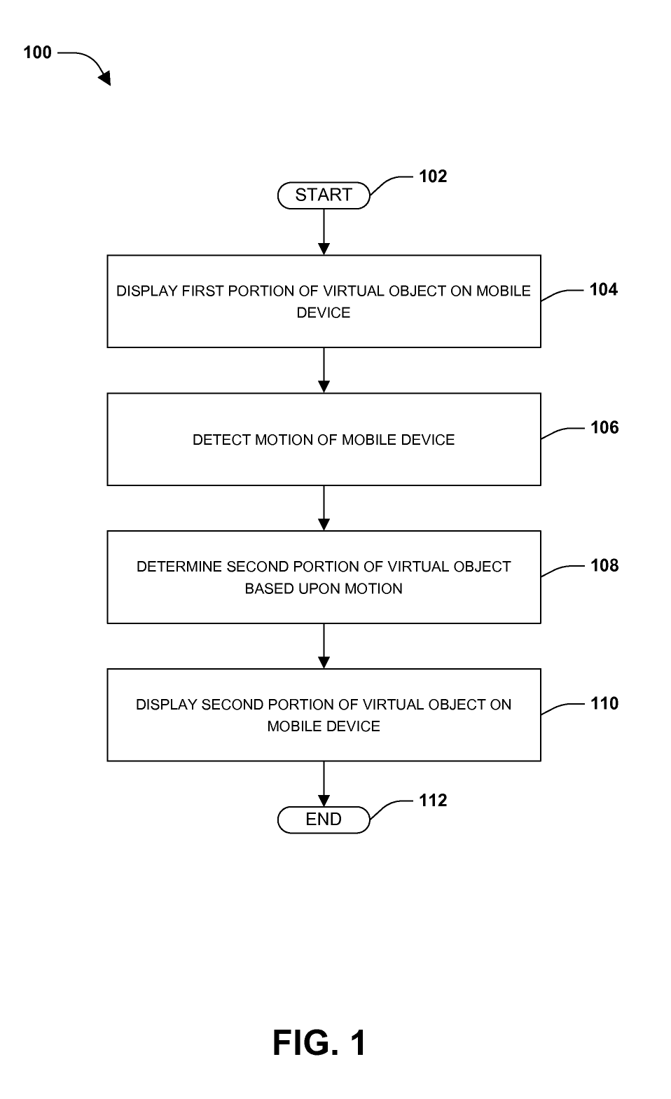

One embodiment of displaying a portion of a virtual object on a mobile device is illustrated by an exemplary method 100 in FIG. 1. At 102, the method beings. At 104, a first portion of a virtual object may be displayed on a mobile device. It may be appreciated that a portion of a virtual object may comprise an electronic illustration (view) of a subset of the virtual object or a view of the entire virtual object. At 106, motion of the mobile device may be detected. The motion may be based upon physical user input (e.g., user movement of the mobile device). In one example, an accelerometer may detect motion as one or more acceleration measurements. In another example, a digital camera may detect motion as a stream of image frames. In yet another example, a magnetometer may detect motion as one or more direction measurements. It may be appreciated that motion may be detected through a combination of techniques (e.g., detected acceleration and a captured stream of images may be utilized in determining motion of a mobile device).

At 108, a second portion of the virtual object may be determined based upon the motion. That is, the second portion may comprise a view of the virtual object corresponding to the detected motion. For example, the second portion may correspond to a view of the virtual object as though the view of the virtual object was panned, zoomed, etc. corresponding to the detected motion. If multiple techniques are used to detect the motion (e.g., a digital camera and an accelerometer), then a Kalman Filter, for example, may be applied to the detected motions to determine the second portion of the virtual object. At 110, the second portion of the virtual object may be displayed on the mobile device. It may be appreciated that the first potion and/or the second portion may be displayed at a 1 to 1 (or other) zoom level with the virtual object. For example, where a mobile device comprises a 1 by 1 inch screen and an image virtual object has a 72 by 72 inch format, then the first portion may comprise a first view of a first 1 by 1 inch portion of the virtual object and the second portion may comprise a second view of a second 1 by 1 inch portion of the virtual object, where the first and second views are different from one another. It may be appreciated, however, that the first portion and the second portion may have the same zoom ratios or dissimilar zoom ratios with one another and/or the virtual object. At 112, the method ends.

It may be appreciated that motion may be mapped to the execution of applications associated with the mobile device. For example, a forward tilt may be mapped to a text editor, a left twist may be mapped to a web browser, a right twist may be mapped to a text document, etc. Upon detecting motion of the mobile device, a corresponding application may be launched.

In another example, a view (e.g., a point of view of the user) of a virtual environment (e.g., a virtual object, a map, an operating system, a graphical user interface, a web browser displaying a web page, etc.) may be mapped to a screen of a mobile device. That is, the screen of the mobile device serves as a window into the virtual environment. The user sees the view of the virtual environment from the user's point of view, through the screen of the mobile device acting as a window. In this way, the user may move the mobile device to navigate the view around/within the virtual environment. It may be appreciated that the view may be consistent with a mental image of a view (portion) of the virtual environment in space as if the virtual environment was floating in front of the user. This provides a more robust user experience than merely implementing ‘next’ and/or ‘previous’ operations resulting from gestures such as roll and/or pan of a mobile device (e.g., around the center of mass of the mobile device), which do not generate a persistent feeling of navigating around a virtual object in space. The windowed navigation provided herein instead provides the user with a persistent feeling of navigating around/within the virtual environment using the mobile device as a window into the virtual environment (e.g., with the virtual environment (e.g., a virtual object, a map, an operating system, a graphical user interface, a web browser displaying a web page, etc.) “floating” in front of the user). That is, motion of the mobile device may be received, the view of the virtual environment may be updated based upon the motion, and the updated view may be displayed to the user on the screen of the mobile device, where the screen of the mobile device serves as a window through which the user may view the virtual environment where this “window” happens to be moveable (e.g., by moving to mobile device) to selectively view different portions of the virtual environment (e.g., left, right, up, down, diagonal, zoom in/out, etc.).

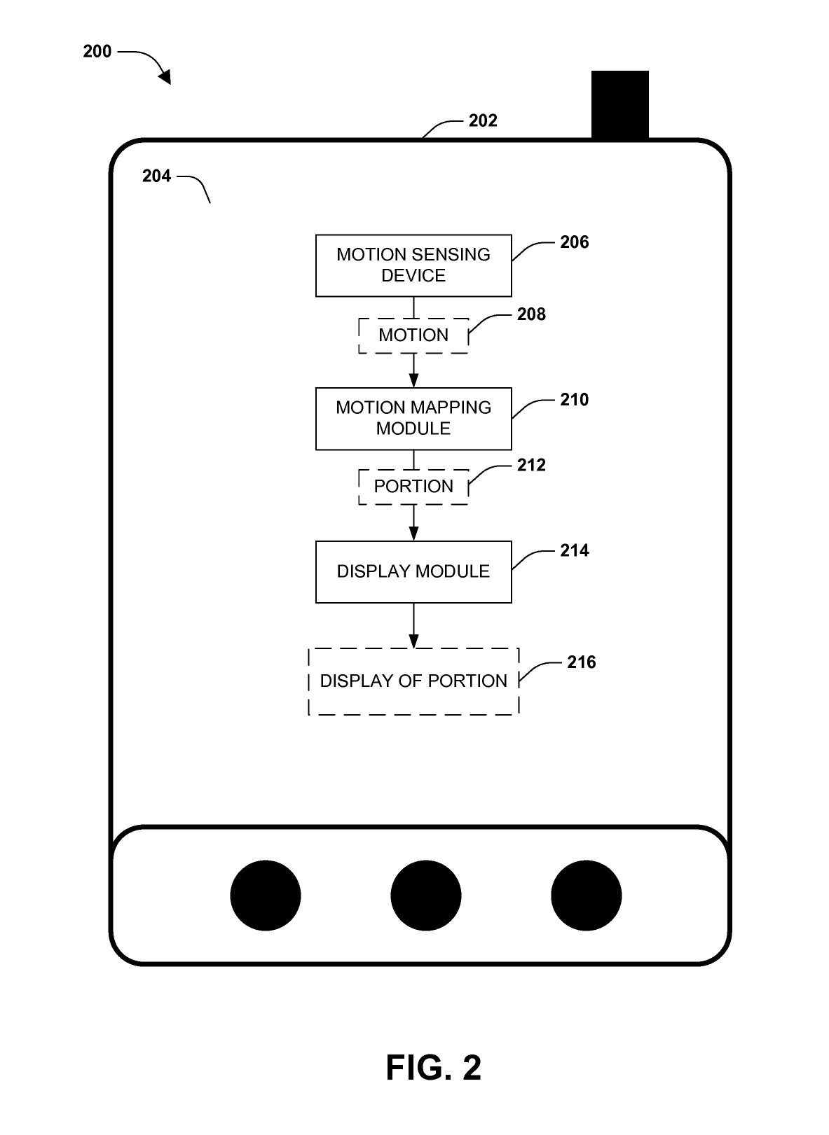

FIG. 2 illustrates an example of a system 200 configured for displaying a portion of a virtual object on a mobile device 202. The system 200 may comprise a motion sensing device 206, a motion mapping module 210, and/or a display module 214. In one example, the motion sensing device 206, the motion mapping module 210, and/or the display module 214 may be incorporated into the mobile device 202.

The motion sensing device 206 may be configured to detect motion 208 of the mobile device 202 (e.g., tilt, pan, roll, and/or other movement of the mobile device 202). In one example, the motion sensing device 206 may be an accelerometer configured to measure acceleration of the mobile device 202. In another example, the motion sensing device 206 may be a digital camera configured to capture a stream of image frames. In yet another example, the motion sensing device 206 may be a magnetometer configured to detect one or more direction measurements (e.g., 10 degrees from North). It may be appreciated that the motion sensing device 206 may comprise other components associated with the mobile device 202, which may be useful in detecting motion 208 of the mobile device 202.

The motion mapping module 210 may be configured to determine a portion 212 of a virtual object based upon the motion 208 of the mobile device 202. In one example, the motion mapping module 210 may be associated with a magnetometer (e.g., a compass). The magnetometer may be configured to detect one or more directions in which the mobile device 202 points. The directions may be mapped to portions of the virtual object. For example, the virtual object may be formatted as a 36 by 24 inch display based upon a 24 inch stand-off distance. A horizontal angle subtended by the virtual object may be around 74 degrees. The motion mapping module 210 may map these angles to dimensions of the virtual object to compute portions (e.g., a pan region) of the virtual object. These portions may be determined based upon directional measurements (motion) detected by the magnetometer. For example, the motion mapping module 210 may determine the portion 212 of the virtual object based upon the mapped angles/dimensions.

In another example, the motion mapping module 210 may be associated with a digital camera. The motion mapping module 210 may receive a stream of image frames detected by the digital camera. The motion mapping module 210 may estimate the optical flow of pixels between subsequent frames in the steam of image frame. In one example, dense optical flow estimation may be performed. In dense optical flow estimation, the motion mapping module 210 may estimate where every pixel of an image frame moves in a subsequent frame. In another example, sparse optical flow estimation may be performed. In sparse optical flow, the motion mapping module 210 may select one or more key features that are tracked in subsequent frames. Features may be selected through a variety of techniques, such as Gabor, Haar wavelets, SIFT, Harris corners, MSER, etc. The key features may be maximized based upon their dot product and pruned based upon a RANSAC procedure to remove outliers. The motion mapping module 210 may determine the portion 212 of the virtual object based upon tracking the key features as change in motion of the mobile device 202.

In another example, the motion mapping module 210 may be associated with an accelerometer configured to measure acceleration of the mobile device 202. The motion mapping module 210 may comprise a physics model configured to interpret changes in acceleration as impulse force upon a pan region comprising the portion 212 of the virtual object. It may be appreciated that the motion mapping module 210 may be associated with a combination of components and may utilize a Kalman Filter to aid in determining the portion 212 of the virtual object.

The display module 214 may be configured to display the portion 212 of the virtual object on the mobile device 202. That is, the display module 214 may generate a display of the portion 216. In one example, the display of the portion 216 may be at a 1 to 1 zoom ratio with the virtual object. That is, the virtual object may be formatted at a particular size and/or viewing distances. To achieve a 1 to 1 zoom ratio, the display of the portion 216 may be formatted at a same zoom ratio as the virtual object. Thus, the display of the portion 216 may be a subset of the virtual object (a 3 by 2 inch portion of a 60 by 84 inch map virtual object).

In another example, multiple mobile devices may be tiled (e.g., place adjacent to one another) to create a larger viewing area for virtual objects, such that larger portions of the virtual objects may be displayed, or rather that multiple portions of the virtual object may be viewed concurrently. For example, a text document virtual object may be formatted at 8.5 by 11 inches. A first mobile device may comprise a screen formatted at 3 by 2 inches, while a second mobile device may comprise a screen formatted at 6 by 2 inches. The first and second mobile device may be tiled in a variety of configurations to create a larger display (e.g., 2 by 9 inches). The mobile devices may be tiled on a planar surface, such as a table, or a 2D manifold (e.g., a cylinder or sphere surface). The topography may be determined by ordered tapping by the user or by automatic means (e.g., structure-from-motion). The relative orientation and/or positions of the mobile devices may be determined by SfM (e.g., a structure-from-motion process configured to find a three-dimensional structure, such as a virtual object, by analyzing the motion of the linked mobile devices over time). In one example, the tiling structure (e.g., multiple mobile devices) may be supported by a hardware device, such as a cradle.

One example of tiling multiple mobile devices is where two users may be exploring a city. A first user may display a 3 by 2 inch portion of a map virtual object on a first cell phone. The second user may display a 3 by 2 inch portion of the map virtual object on a second cell phone. The users may link their respective cell phones together. The linked cell phones may be configured as a single larger display (e.g., 3 by 4 inches or 6 by 2 inches). The larger display of the linked cell phones allows larger portions of virtual objects to be displayed. Motion of the linked cell phones may be utilized in determine portions of the map virtual object for display. In this way, the linked cell phones allow for larger portions of a virtual object to be determined and displayed based upon motion of the linked cell phones. It may be appreciated that linked cell phones may be unlinked, and, in one example, the collaborative experience may be retained in one or more of the respective devices (e.g., in cache) so that the users can selectively access the same if subsequently desired.

Other examples of utilizing motion to display portions of virtual objects are shared picture viewing, turn-by-turn driving directions, movie watching, web browsing, etc. It may be appreciated that multiple linked mobile devices may be utilized in displaying larger portions of virtual objects in these and other scenarios.

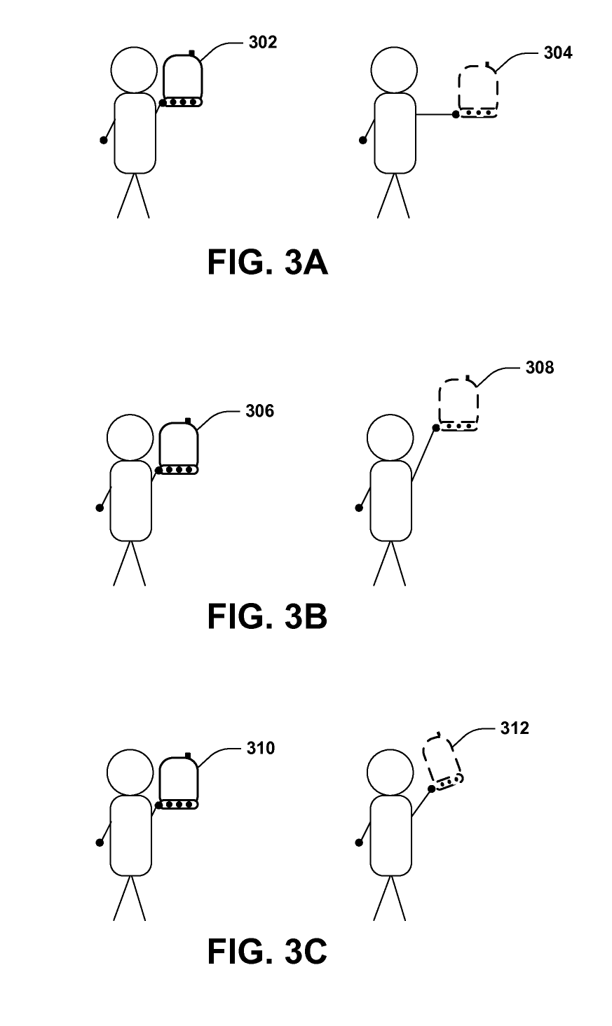

FIG. 3A illustrates an example of a user panning a mobile device to the right. The example illustrates a user holding the mobile device in a first position 302. The user may pan the mobile device to the right into a second position 304. The change in position from the first position 302 to the second position 304 may be detected as motion of the mobile device. In one example, a first portion (e.g., a left portion of a user interface virtual object) of a virtual object may be displayed on the mobile device when the mobile device is at the first position 302. Upon detecting the pan motion of the mobile device to the second position 304, a second portion (e.g., a right portion of the user interface virtual object) may be determined and/or displayed on the mobile device. In this way, the user may naturally navigate through views of the virtual object while holding the mobile device with a single hand.

FIG. 3B illustrates an example of a user moving a mobile device away from the user. The example illustrates a user holding the mobile device in a first position 306. The user may move the mobile device away from the user into a second position 308. The change in position from the first position 306 to the second position 308 may be detected as motion of the mobile device. In one example, a first portion (e.g., a middle portion of a web page virtual object) of a virtual object may be displayed on the mobile device when the mobile device is at the first position 306. Upon detecting the move away from user motion of the mobile device to the second position 308, a second portion (e.g., a zoomed-in middle portion of the web page virtual) of the virtual object may be determined and/or displayed on the mobile device. In this way, the user may naturally zoom in/out views of virtual objects while holding the mobile device with a single hand.

FIG. 3C illustrates an example of a user tilting a mobile device in a counterclockwise direction. The example illustrates a user holding the mobile device in a first position 310. The user may tilt the mobile device in a counterclockwise direction into a second position 312. The change in position from the first position 310 to the second position 312 may be detected as motion of the mobile device. In one example, a first portion (e.g., a straight on view of a middle portion of an image virtual object) of a virtual object may be displayed on the mobile device when the mobile device is at the first position 310. Upon detecting the counterclockwise tilt of the mobile device to the second position 312, a second portion (e.g., a tiled view of the middle portion of the image virtual object) of the virtual object may be determined and/or displayed on the mobile device. In this way, the user may naturally navigate through view angles of the virtual object while holding the mobile device with a single hand.

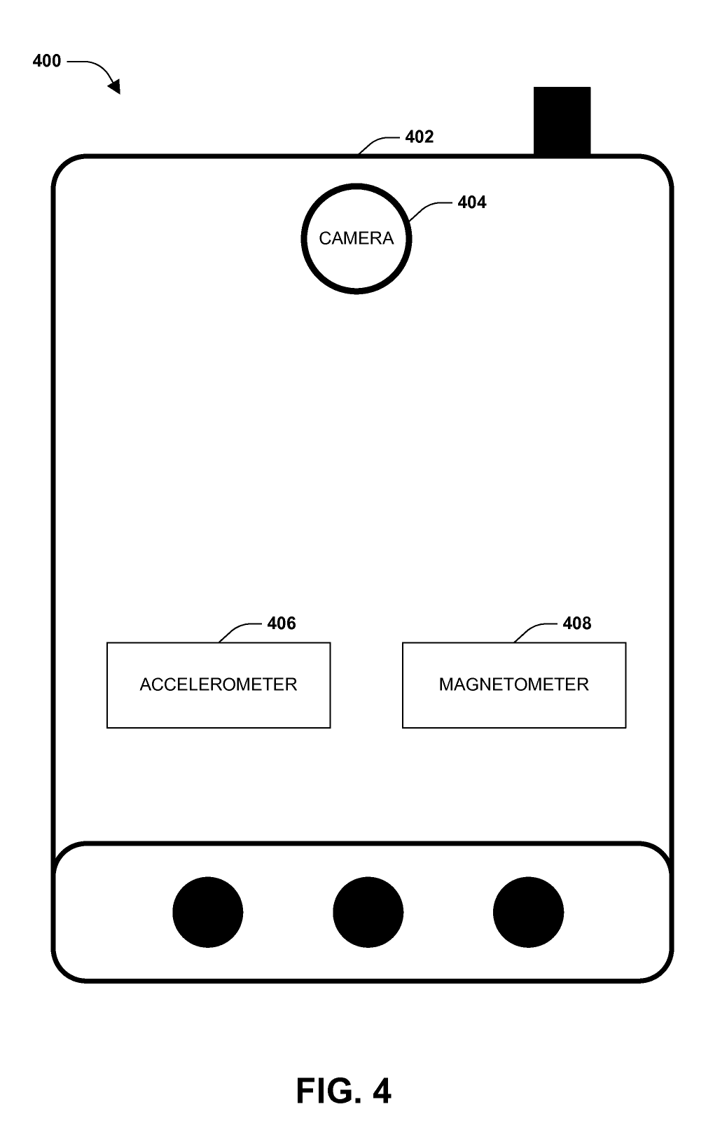

FIG. 4 illustrates an example 400 of a cell phone mobile device 402. The cell phone mobile device 402 comprises a digital camera 404, an accelerometer 406, and a magnetometer 408. The digital camera 404 may be configured to capture a stream of image frames that may be utilized in detecting motion of the cell phone mobile device 402. The accelerometer 406 may be configured to measure acceleration of the mobile device 402, which may be utilized in detecting motion of the cell phone mobile device 402. The magnetometer 408 may be configured to measure direction of the mobile device 402, which may be utilized in detecting motion of the cell phone mobile device 402.

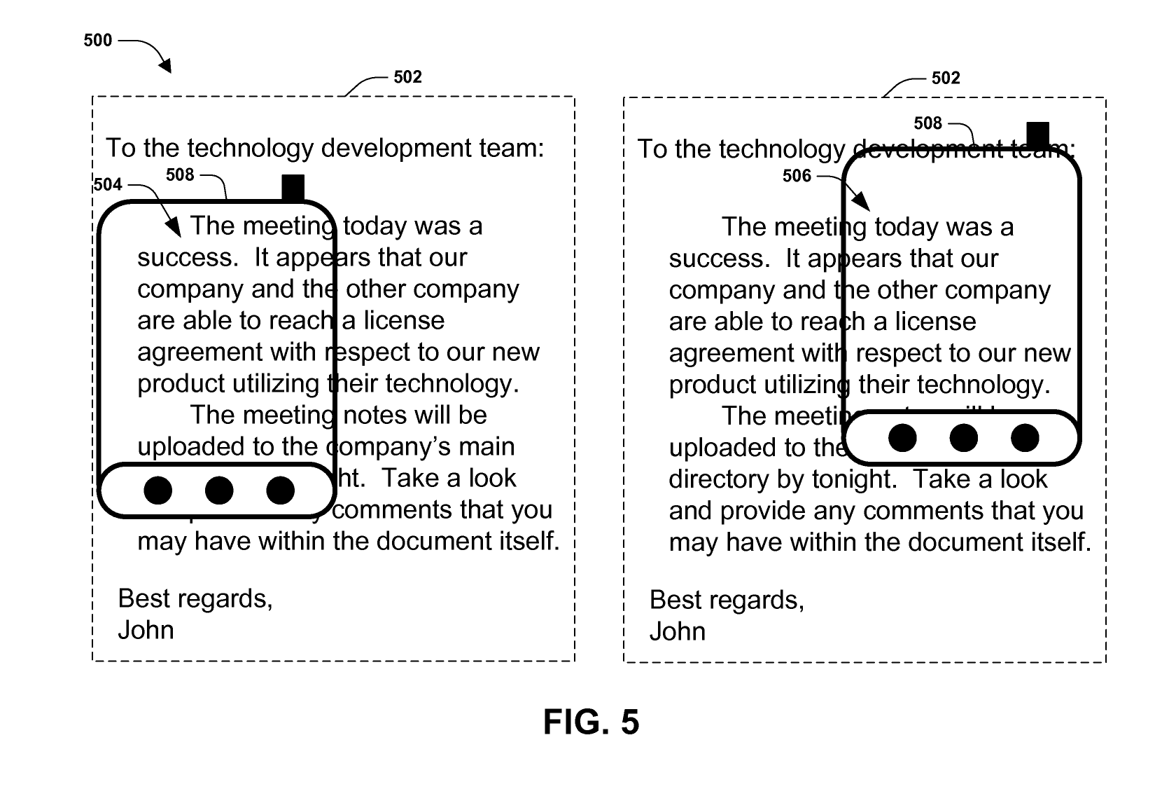

FIG. 5 illustrates an example 500 of displaying a first portion 504 of an email virtual object 502 and subsequently a second portion 506 of the email virtual object 502 based upon motion of a PDA mobile device 508. The PDA mobile device 508 may comprise an email application configured to allow a user to read and write email. The PDA mobile device 508 may comprise a 4 by 3 inch screen, for example. A user may not be able to adequately view emails because the emails may be formatted within the email application larger than the 4 by 3 inch screen of the PDA mobile device 508 (e.g., the email 502 may be formatted at 8.5 by 11 inches). To provide a robust viewing experience for the user, various portions of the email virtual object 502 may be displayed on the PDA mobile device 508 based upon motion of the PDA mobile device 508.

It may be appreciated that the email virtual object 502 exists electronically within the email application and some or all of it is viewable through the PDA mobile device 508 (e.g., depending upon a level of zoom/magnification implemented in the PDA mobile device 508). It will be appreciated that the entire email virtual object 502 is illustrated in example 500 for illustrative purposes (e.g., to illustrate what the entire object 502 comprises), but that merely a portion of the object is displayed or viewable through the PDA mobile device 508. That is, in the illustrated example, the PDA mobile device 508 is operating at a 1 to 1 zoom level relative to the email virtual object 502 such that merely the first portion 504 of the email virtual object 508 is viewable through the PDA mobile device 508, and the remainder of the object 502 (that is not presently displayed through the PDA mobile device 508) is illustrated in FIG. 500 outside of the PDA mobile device 508 merely to illustrate what the entirety of the object 502 comprises. It will be appreciated that, as provided herein, a second portion 506 of the email virtual object 508 (e.g., different than the first portion 504 of the email virtual object 508) would be viewable through the PDA mobile device 508 if the PDA mobile device 508 is moved (e.g., panned).

In one example, the first portion 504 of the email virtual object 502 may be displayed on the PDA mobile device 508 at a 1 to 1 zoom level with the email virtual object 502. The user may pan the PDA mobile device 508 to the right and up to a second position. The pan movement may be detected as motion of the PDA mobile device 508. The second portion 506 of the email virtual object 502 may be determined based upon the detected motion (e.g., the pan right and up may correspond to the second portion 506 as a view of the email virtual object 502 that is to the right and up from the first portion 504). The second portion 506 may be displayed on the PDA mobile device 508. In this way, the user may pan the view of emails within the email application based upon naturally moving the PDA mobile device 508 with a single hand. It may be appreciated that in one example, the email virtual object 502 may be interpreted as a sub-virtual object of an email application virtual object, such that portions of the email application virtual object and/or the email virtual object 502 may be determined and/or displayed based upon motion of the PDA mobile device 508.

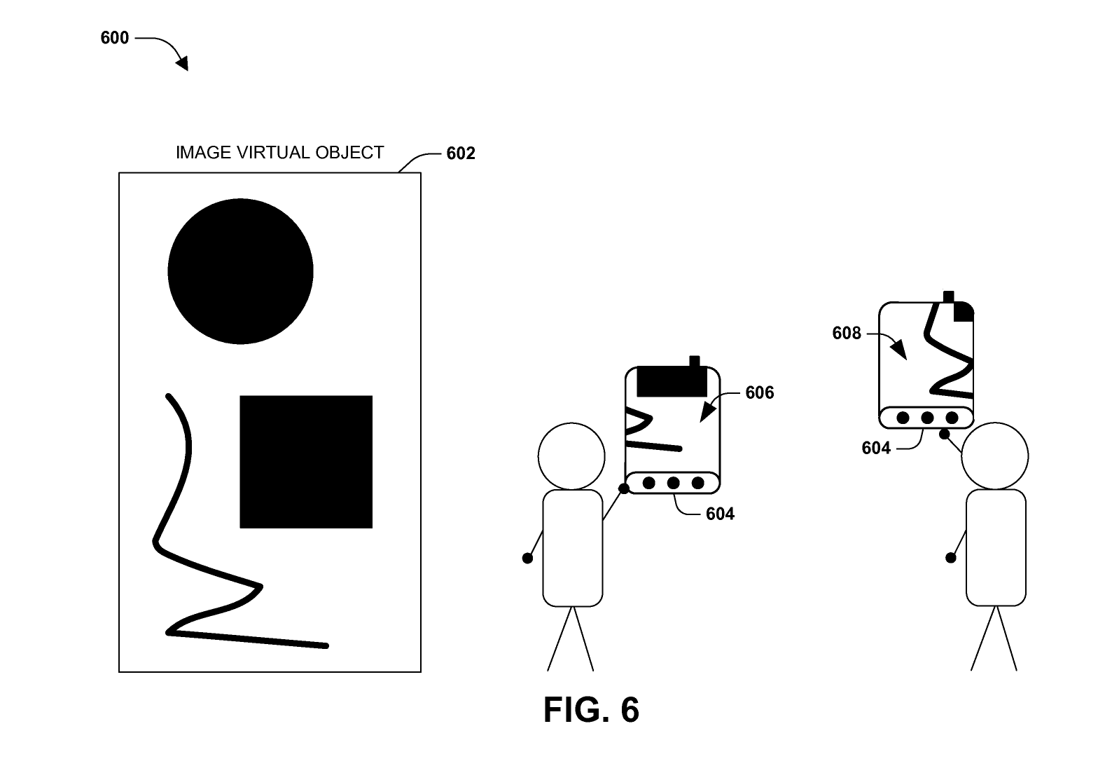

FIG. 6 illustrates an example 600 of displaying a first portion 606 of an image virtual object 602 and subsequently a second portion 608 of the image virtual object 602 based upon motion of a cell phone mobile device 604. The cell phone mobile device 604 may comprise an image viewing application configured to allow a user to view and share images (image virtual objects). The cell phone mobile device 604 may comprise a 3 by 2 inch screen, for example. A user may not be able to adequately view images within the image viewing application because the images may be formatted larger than 3 by 2 inches (e.g., the image virtual object 602 may be formatted at 800 by 600 pixel resolution, where as the cell phone mobile device 602 may comprise a 480 by 320 pixel resolution screen). To provide a robust viewing experience for the user, various portions of the image virtual object 602 may be displayed on the cell phone mobile device 604 based upon motion of the cell phone mobile device 604.

In one example, the first portion 606 of the image virtual object 602 may be displayed on the cell phone mobile device 604. The user may pan the cell phone mobile device 604 to the left and up to a second position. The pan movement may be detected as motion of the cell phone mobile device 604. The second portion 608 of the image virtual object 602 may be determined based upon the detected motion (e.g., the pan left and up may correspond to the second portion 608 as a view of the image virtual object 602 that is to the left and up from the first portion 606). The second portion 608 may be displayed on the cell phone mobile device 604. In this way, the user may pan the view of images within the image application based upon natural movement of the cell phone mobile device 604. It may be appreciated that in one example, the image virtual object 602 may be sub-virtual object of an image application virtual object, such that portions of the image application virtual object and/or the image virtual object 602 may be determined and/or displayed based upon motion of the cell phone mobile device 604.

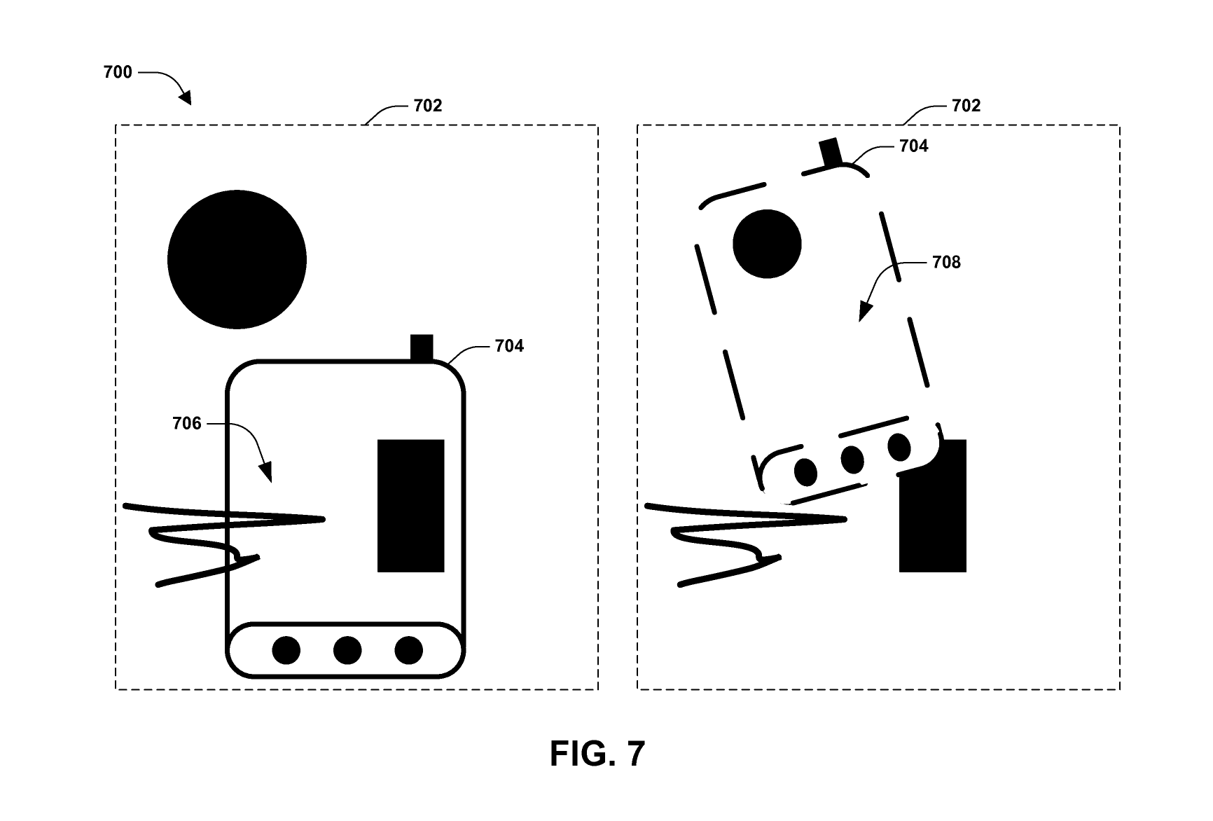

FIG. 7 illustrates an example 700 of displaying a first portion 706 of an image virtual object 702 and subsequently a second portion 708 based upon motion of a mobile device 704. The mobile device 704 may comprise an image viewing application configured to allow a user to view and share images. To provide a robust viewing experience for the user, various portions of the image virtual object 702 may be displayed on the mobile device 704 based upon motion of the mobile device 704.

It may be appreciated that the image virtual object 702 exists electronically within the image viewing application and some or all of it is viewable through the mobile device 704 (e.g., depending upon a level of zoom/magnification implemented in the mobile device). It will be appreciated that the entire image virtual object 702 is illustrated in example 700 for illustrative purposes (e.g., to illustrate what the entire object 702 comprises), but that merely a portion of the object is displayed or viewable through the mobile device 704. That is, in the illustrated example, the mobile device 704 is operating at a 1 to 1 zoom level relative to the image virtual object 702 such that merely the first portion 706 of the image virtual object 702 is viewable through the mobile device 704, and the remainder of the image virtual object 702 (that is not presently displayed through the mobile device 704) is illustrated in FIG. 700 outside of the mobile device 704 merely to illustrate what the entirety of the object 702 comprises. It will be appreciated that, as provided herein, the second portion 708 of the image virtual object 702 (e.g., different than the first portion 704 of the image virtual object 702) would be viewable through the mobile device 704 if the mobile device 704 is moved (e.g., panned).

In one example, the first portion 706 of the image virtual object 702 may be displayed on the mobile device 704. The user may pan the mobile device 704 to the left and up, while tilting the mobile device 704 counterclockwise. The left and up pan movement and the counterclockwise tilt may be detect as motion of the mobile device 704. It may be appreciated that the pan and the tilt may be detected together as a single motion or as two separate motions. The second portion 708 of the image virtual object 702 may be determined based upon the detect motion(s). For example, the second portion 708 may be a panned and zoomed in view of the image virtual object 702. That is, the second portion 708 may represent a view of the image virtual object 702 that is panned to the left and up based upon the left and up pan movement and is zoomed in based upon the counterclockwise tilt.

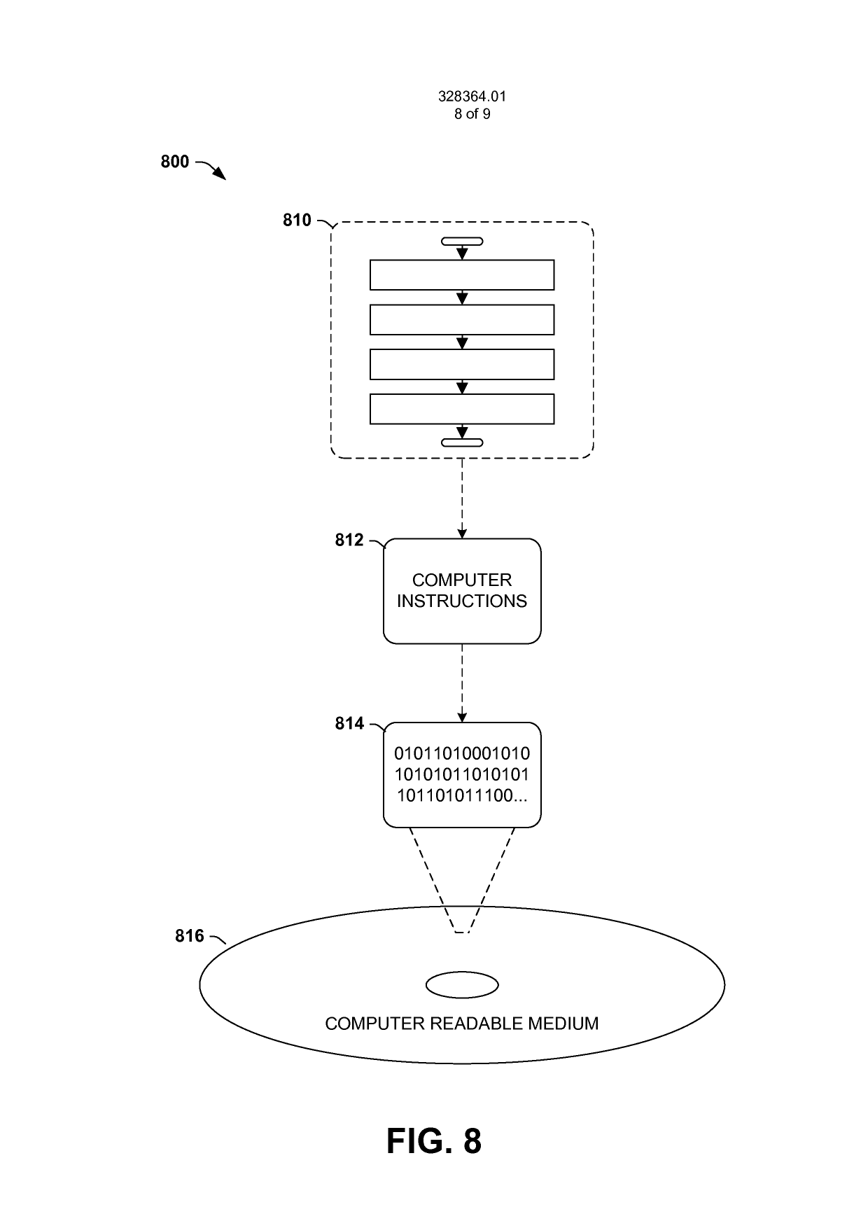

Still another embodiment involves a computer-readable medium comprising processor-executable instructions configured to implement one or more of the techniques presented herein. An exemplary computer-readable medium that may be devised in these ways is illustrated in FIG. 8, wherein the implementation 800 comprises a computer-readable medium 816 (e.g., a CD-R, DVD-R, or a platter of a hard disk drive), on which is encoded computer-readable data 814. This computer-readable data 814 in turn comprises a set of computer instructions 812 configured to operate according to one or more of the principles set forth herein. In one such embodiment 800, the processor-executable computer instructions 812 may be configured to perform a method 810, such as the exemplary method 100 of FIG. 1, for example. In another such embodiment, the processor-executable instructions 812 may be configured to implement a system, such as the exemplary system 200 of FIG. 2, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

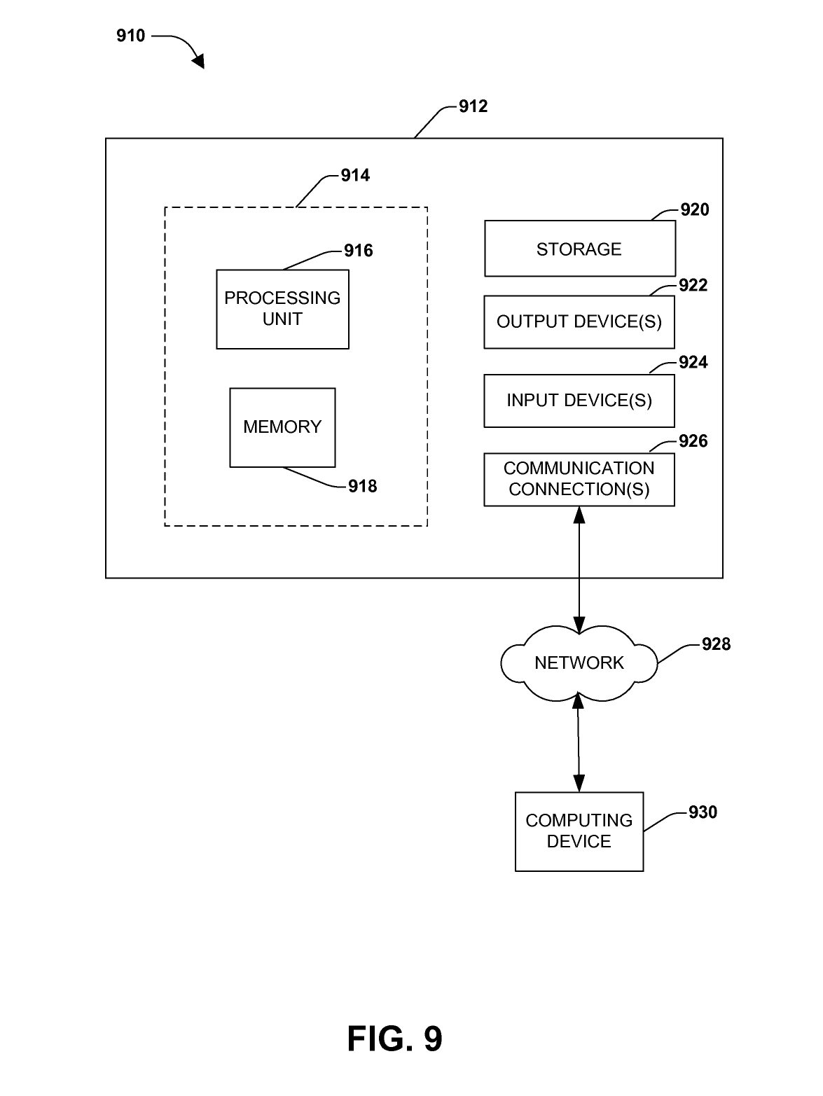

FIG. 9 and the following discussion provide a brief, general description of a suitable computing environment to implement embodiments of one or more of the provisions set forth herein. The operating environment of FIG. 9 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 910 comprising a computing device 912 configured to implement one or more embodiments provided herein. In one configuration, computing device 912 includes at least one processing unit 916 and memory 918. Depending on the exact configuration and type of computing device, memory 918 may be volatile (such as RAM, for example), non-volatile (such as ROM, flash memory, etc., for example) or some combination of the two. This configuration is illustrated in FIG. 9 by dashed line 914.

In other embodiments, device 912 may include additional features and/or functionality. For example, device 912 may also include additional storage (e.g., removable and/or non-removable) including, but not limited to, magnetic storage, optical storage, and the like. Such additional storage is illustrated in FIG. 9 by storage 920. In one embodiment, computer readable instructions to implement one or more embodiments provided herein may be in storage 920. Storage 920 may also store other computer readable instructions to implement an operating system, an application program, and the like. Computer readable instructions may be loaded in memory 918 for execution by processing unit 916, for example.

The term “computer readable media” as used herein includes computer storage media. Computer storage media includes volatile and nonvolatile, removable and non-removable media implemented in any method or technology for storage of information such as computer readable instructions or other data. Memory 918 and storage 920 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 912. Any such computer storage media may be part of device 912.

Device 912 may also include communication connection(s) 926 that allows device 912 to communicate with other devices. Communication connection(s) 926 may include, but is not limited to, a modem, a Network Interface Card (NIC), an integrated network interface, a radio frequency transmitter/receiver, an infrared port, a USB connection, or other interfaces for connecting computing device 912 to other computing devices. Communication connection(s) 926 may include a wired connection or a wireless connection. Communication connection(s) 926 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 912 may include input device(s) 924 such as keyboard, mouse, pen, voice input device, touch input device, infrared cameras, video input devices, and/or any other input device. Output device(s) 922 such as one or more displays, speakers, printers, and/or any other output device may also be included in device 912. Input device(s) 924 and output device(s) 922 may be connected to device 912 via a wired connection, wireless connection, or any combination thereof. In one embodiment, an input device or an output device from another computing device may be used as input device(s) 924 or output device(s) 922 for computing device 912.

Components of computing device 912 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 912 may be interconnected by a network. For example, memory 918 may be comprised of multiple physical memory units located in different physical locations interconnected by a network.

Those skilled in the art will realize that storage devices utilized to store computer readable instructions may be distributed across a network. For example, a computing device 930 accessible via a network 928 may store computer readable instructions to implement one or more embodiments provided herein. Computing device 912 may access computing device 930 and download a part or all of the computer readable instructions for execution. Alternatively, computing device 912 may download pieces of the computer readable instructions, as needed, or some instructions may be executed at computing device 912 and some at computing device 930.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for displaying a portion of a virtual object on a mobile device, comprising:
displaying a first portion of a virtual object on a mobile device;
detecting motion of the mobile device;
determining a second portion of the virtual object based upon the motion; and
displaying the second portion of the virtual object on the mobile device.

2. The method of claim 1, comprising displaying at least one of the first portion and the second portion at a 1 to 1 zoom level with the virtual object.

3. The method of claim 1, the first portion and the second portion having a same zoom ratio.

4. The method of claim 1, the detecting motion of a mobile device comprising at least one of:
detecting motion using an accelerometer within the mobile device;
detecting motion using a digital camera within the mobile device; and
detecting motion using a magnetometer within the mobile device.

5. The method of claim 1, the detecting motion of a mobile device comprising:
detecting motion using at least two of a digital camera, an accelerometer, a magnetometer.

6. The method of claim 5, the determining a second portion of the virtual object comprising:
applying a Kalman Filter to the detected motion.

7. The method of claim 1, the determining a second portion of the virtual object comprising at least one of:
determining the second portion of the virtual object by panning a view of the virtual object based upon the motion; and
determining the second portion of the virtual object by zooming a view of the virtual object based upon the motion.

8. The method of claim 1, comprising:
detecting more than one mobile device in a linked configuration;
detecting motion of the linked mobile devices;
determining the second portion of the virtual object based upon the motion of the linked mobile devices; and
displaying the second portion of the virtual object on the linked mobile devices.

9. The method of claim 1, the detecting motion of a mobile device, comprising at least one of:
detecting a tilt of the mobile device;
detecting a pan of the mobile device; and
detecting a roll of the mobile device.

10. The method of claim 1, comprising:
launching an application associated with the motion.

11. A system for displaying a portion of a virtual object on a mobile device, comprising:
a motion sensing device configured to:
detect motion of a mobile device;
a motion mapping module configured to:
determine a portion of a virtual object based upon the motion of the mobile device; and
a display module configured to:
display the portion of a virtual object on the mobile device.

12. The system of claim 11, the motion sensing device configured to detect at least one of:
a tilt of the mobile device;
a pan of the mobile device; and
a roll of the mobile device.

13. The system of claim 11, the first motion sensing device comprising an accelerometer.

14. The system of claim 11, the first motion sensing device comprising a digital camera.

15. The system of claim 11, the first motion sensing device comprising a magnetometer.

16. The system of claim 11, the motion mapping module configured to:
perform an application launch action based upon the motion.

17. The system of claim 13, the motion mapping module configured to:
receive an acceleration measurement within the motion detected by the accelerometer; and
determine the portion of the virtual object based upon panning a view of the virtual object using the acceleration measurement.

18. The system of claim 14, the motion mapping module configured to:
receive a stream of image frames within the motion detected by the digital camera; and
determine the portion of the virtual object based upon performing a dense optical flow estimation or a sparse optical flow estimation upon the stream of image frames.

19. The system of claim 15, the motion mapping module configured to:
receive a direction measurement within the motion detected by the magnetometer;
determine the portion of the virtual object based upon panning a view of the virtual object using the direction measurement and a subtended angle of the virtual object and the mobile device.

20. A method for windowed navigation of a virtual environment on a mobile device, comprising:
mapping a screen of a mobile device to a view of a virtual environment;
receiving motion of the mobile device;
updating the view based upon the motion; and
displaying the updated view on the screen of the mobile device.
